(19) United States
(12) Patent Application Publication
(10) Pub. No.: US 2026/0089613 A1
(43) Pub. Date: Mar. 26, 2026

(54) UNSYNCHRONIZED SERVICE DISCOVERY

(71) Applicant: Samsung Electronics Co., Ltd., Suwon-si (KR)

(72) Inventors: Bilal Sadiq, Plano, TX (US); Yue Qi, Plano, TX (US); Vishnu Vardhan Ratnam, Frisco, TX (US); Peshal Nayak, Plano, TX (US); Rubayet Shafin, Frisco, TX (US); Boon Loong Ng, Plano, TX (US)

(21) Appl. No.: 19/337,803

(22) Filed: Sep. 23, 2025

Related U.S. Application Data
(60) Provisional application No. 63/699,359, filed on Sep. 26, 2024.
(60) Provisional application No. 63/703,028, filed on Oct. 3, 2024.
(60) Provisional application No. 63/705,776, filed on Oct. 10, 2024.
(60) Provisional application No. 63/707,457, filed on Oct. 15, 2024.
(60) Provisional application No. 63/844,983, filed on Jul. 16, 2025.

(51) Int. Cl. H04W 48/16; H04W 8/00

(52) U.S. Cl. CPC H04W 48/16; H04W 8/005

(57) ABSTRACT

An electronic device includes a transceiver configured to monitor for receipt of at least one publish message from another electronic device. The electronic device also includes a processor operably coupled to the transceiver. The processor is configured to, upon receipt of a first publish message, determine whether the first publish message is relevant to an application of the electronic device. In response to a determination that the first publish message is relevant, the processor is also configured to (i) declare a discovery result event, (ii) generate follow-up message, and (iii) in response to the declaration of the discovery event, cause the transceiver to transmit the follow-up message to the other electronic device.

### CROSS-REFERENCE TO RELATED APPLICATION(S) AND CLAIM OF PRIORITY

This application claims priority under 35 U.S.C. § 119 (e) to U.S. Provisional Patent Application No. 63/699,359 filed on Sep. 26, 2024, U.S. Provisional Patent Application No. 63/703,028 filed on Oct. 3, 2024, U.S. Provisional Patent Application No. 63/705,776 filed on Oct. 10, 2024, U.S. Provisional Patent Application No. 63/707,457 filed on Oct. 15, 2024, and U.S. Provisional Patent Application No. 63/844,983 filed on Jul. 16, 2025. The above-identified provisional patent applications are hereby incorporated by reference in their entirety.

### TECHNICAL FIELD

This disclosure relates generally to wireless networks. More specifically, this disclosure relates to unsynchronized service discovery (USD).

### BACKGROUND

Wireless Local Area Network (WLAN) technology allows devices to access the internet in the 2.4 GHz, 5 GHZ, 6 GHz or 60 GHz frequency bands. WLANs are based on the Institute of Electrical and Electronic Engineers (IEEE) 802.11 standards. The IEEE 802.11 family of standards aim to increase speed and reliability and to extend the operating range of wireless networks.

The demand of wireless data traffic is rapidly increasing due to the growing popularity among consumers and businesses of smart phones and other mobile data devices, such as tablets, “note pad” computers, net books, eBook readers, and machine type of devices. In order to address the issue of increasing bandwidth requirements that are demanded for wireless communications systems, different schemes are being developed to allow multiple user terminals to communicate with a single access point by sharing the channel resources while achieving high data throughputs. Multiple Input Multiple Output (MIMO) technology represents one such approach that has emerged as a popular technique. MIMO has been adopted in several wireless communications standards such 802.11ac, 802.11ax etc.

### SUMMARY

This disclosure provides apparatuses and methods for USD.

In one embodiment, an electronic device is provided. The electronic device includes a transceiver configured to monitor for receipt of at least one publish message from another electronic device. The electronic device also includes a processor operably coupled to the transceiver. The processor is configured to, upon receipt of a first publish message, determine whether the first publish message is relevant to an application of the electronic device. In response to a determination that the first publish message is relevant, the processor is also configured to (i) declare a discovery result event, (ii) generate a follow-up message, and (iii) in response to the declaration of the discovery event, cause the transceiver to transmit the follow-up message to the other electronic device.

In another embodiment, an electronic device is provided. The electronic device includes a transceiver configured to, during an unsynchronized service discovery (USD) publish mode, (i) transmit an unsolicited publish message, the unsolicited publish message indicating that further service discovery (FSD) is not required, and (ii) after transmission of the unsolicited publish message, monitor for receipt of a subscribe message from another electronic device. The electronic device also includes a processor operably coupled to the transceiver. The processor is configured to, upon receipt a subscribe message that does not include service specific information (SSI), determine whether the subscribe message is relevant to an application of the electronic device. In response to a determination that the subscribe message is relevant, the processor is further configured to (i) declare a replied event, (ii) generate a solicited publish message, and (iii) in response to declaration of the replied event, cause the transceiver to transmit at least one solicited publish message to the other electronic device, and declare that a USD publish instance has successfully concluded.

In yet another embodiment, a method of operating an electronic device is provided. The method includes monitoring for receipt of at least one publish message from another electronic device, and upon receipt of a first publish message, determining whether the first publish message is relevant to an application of the electronic device. The method also includes, in response to a determination that the first publish message is relevant, declaring a discovery result event, generating a follow-up message, and in response to the declaration of the discovery result event, transmitting the follow-up message to the other electronic device.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to various embodiments of the present disclosure;

FIG. 2A illustrates an example AP according to various embodiments of the present disclosure;

FIG. 2B illustrates an example STA according to various embodiments of this disclosure;

FIG. 3 illustrates an example method for reactive mode subscribe according to embodiments of the present disclosure;

FIG. 4 illustrates an example USD publisher behavior according to embodiments of the present disclosure;

FIGS. 5-7 illustrate other examples of USD publisher behavior according to embodiments of the present disclosure;

FIG. 8 illustrates an example method for USD according to embodiments of the present disclosure; and

FIG. 9 illustrates another example method for USD according to embodiments of the present disclosure.

### DETAILED DESCRIPTION

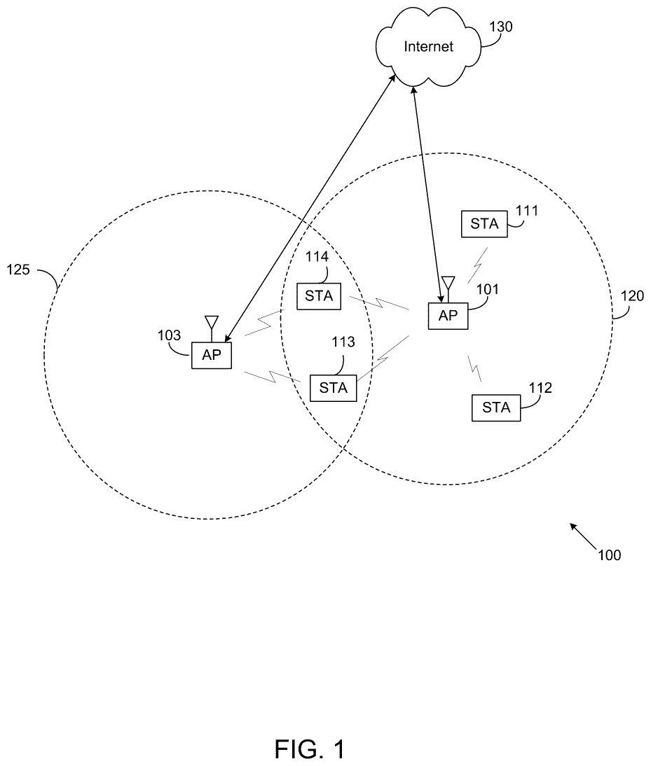

FIGS. 1 through 9, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged system or device.

Existing WLAN standards support multiple bands of operation, where an access point (AP) and a non-AP device may communicate with each other, called links. Thus, both the AP and non-AP device may be capable of communicating on different bands/links, which is referred to as mutli-link operation (MLO). Devices capable of such MLO are referred to as multi-link devices (MLDs).

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes APs 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA (e.g., an AP STA). Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.). This type of STA may also be referred to as a non-AP STA.

In various embodiments of this disclosure, each of the APs 101 and 103 and each of the STAs 111-114 may be an MLD. In such embodiments, APs 101 and 103 may be AP MLDs, and STAs 111-114 may be non-AP MLDs. Each MLD is affiliated with more than one STA. For convenience of explanation, an AP MLD is described herein as affiliated with more than one AP (e.g., more than one AP STA), and a non-AP MLD is described herein as affiliated with more than one STA (e.g., more than one non-AP STA).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for facilitating multi-link adaptation based on network quality monitoring. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

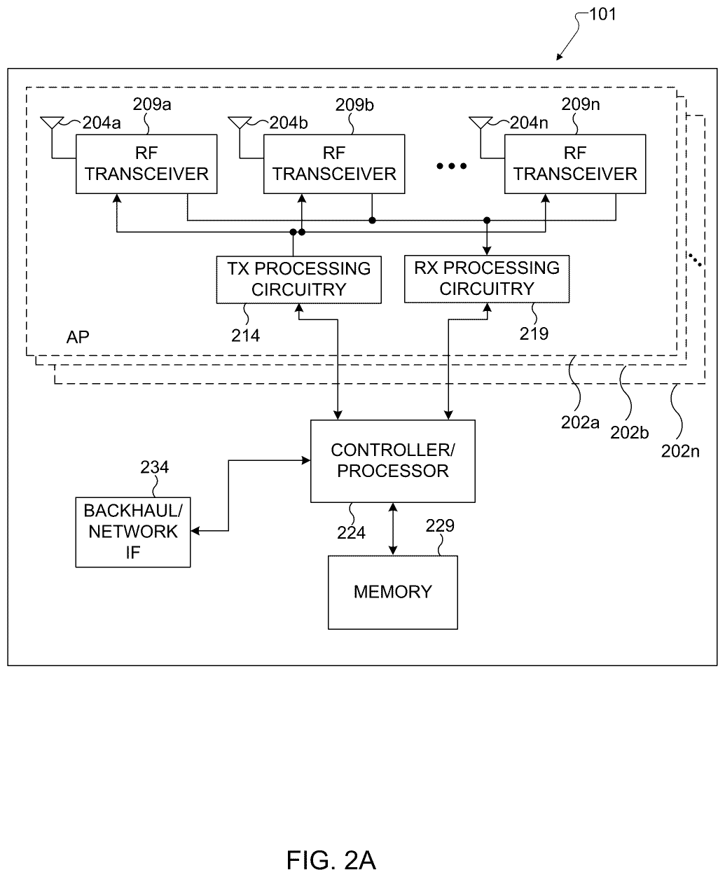

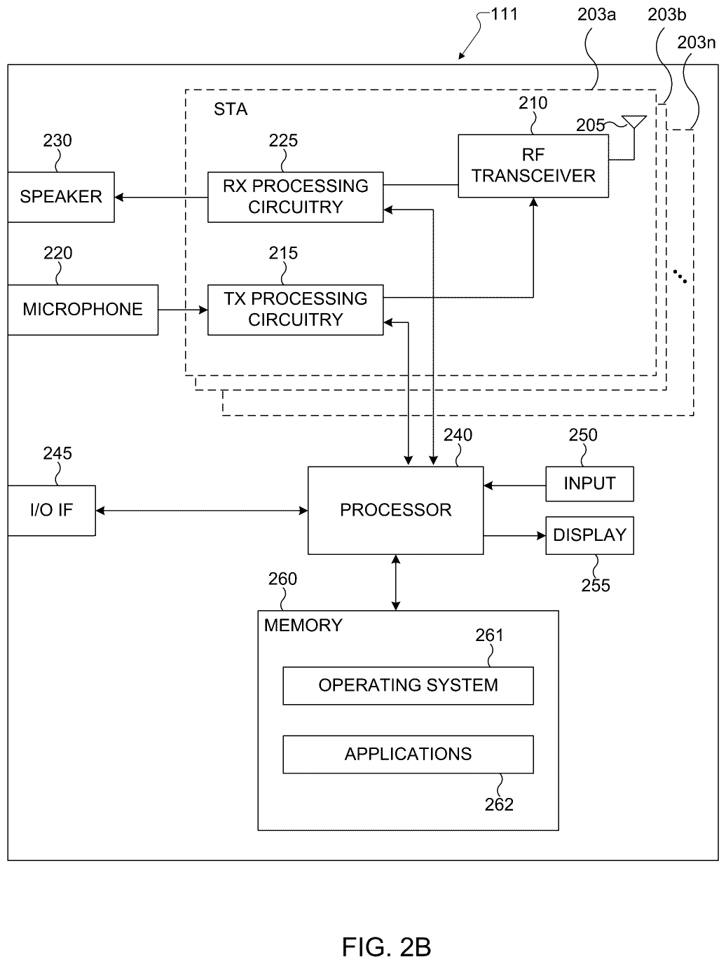

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. In the embodiments discussed below, the AP 101 is an AP MLD. However, APs come in a wide variety of configurations, and FIG. 2A does not limit the scope of this disclosure to any particular implementation of an AP.

The AP MLD 101 is affiliated with multiple APs 202a-202n (which may be referred to, for example, as AP1-APn). Each of the affiliated APs 202a-202n includes multiple antennas 204a-204n, multiple RF transceivers 209a-209n, transmit (TX) processing circuitry 214, and receive (RX) processing circuitry 219. The AP MLD 101 also includes a controller/processor 224, a memory 229, and a backhaul or network interface 234.

The illustrated components of each affiliated AP 202a-202n may represent a physical (PHY) layer and a lower media access control (LMAC) layer in the open systems interconnection (OSI) networking model. In such embodiments, the illustrated components of the AP MLD 101 represent a single upper MAC (UMAC) layer and other higher layers in the OSI model, which are shared by all of the affiliated APs 202a-202n.

For each affiliated AP 202a-202n, the RF transceivers 209a-209n receive, from the antennas 204a-204n, incoming RF signals, such as signals transmitted by STAs in the network 100. In some embodiments, each affiliated AP 202a-202n operates at a different bandwidth, e.g., 2.4 GHz, 5 GHZ, or 6 GHz, and accordingly the incoming RF signals received by each affiliated AP may be at a different frequency of RF. The RF transceivers 209a-209n down-convert the incoming RF signals to generate IF or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

For each affiliated AP 202a-202n, the TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-convert the baseband or IF signals to RF signals that are transmitted via the antennas 204a-204n. In embodiments wherein each affiliated AP 202a-202n operates at a different bandwidth, e.g., 2.4 GHz, 5 GHz, or 6 GHz, the outgoing RF signals transmitted by each affiliated AP may be at a different frequency of RF.

The controller/processor 224 can include one or more processors or other processing devices that control the overall operation of the AP MLD 101. For example, the controller/processor 224 could control the reception of forward channel signals and the transmission of reverse channel signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support orthogonal frequency division multiple access (OFDMA) operations in which outgoing signals are assigned to different subsets of subcarriers for different recipients (e.g., different STAs 111-114). Any of a wide variety of other functions could be supported in the AP MLD 101 by the controller/processor 224 including facilitating multi-link adaptation based on network quality monitoring. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP MLD 101 to communicate with other devices or systems over a backhaul connection or over a network. The interface 234 could support communications over any suitable wired or wireless connection(s). For example, the interface 234 could allow the AP MLD 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP MLD 101 may include circuitry and/or programming for facilitating multi-link adaptation based on network quality monitoring. Although FIG. 2A illustrates one example of AP MLD 101, various changes may be made to FIG. 2A. For example, the AP MLD 101 could include any number of each component shown in FIG. 2A. As a particular example, an AP MLD 101 could include a number of interfaces 234, and the controller/processor 224 could support routing functions to route data between different network addresses. As another particular example, while each affiliated AP 202a-202n is shown as including a single instance of TX processing circuitry 214 and a single instance of RX processing circuitry 219, the AP MLD 101 could include multiple instances of each (such as one per RF transceiver) in one or more of the affiliated APs 202a-202n. Alternatively, only one antenna and RF transceiver path may be included in one or more of the affiliated APs 202a-202n, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. In the embodiments discussed below, the STA 111 is a non-AP MLD. However, STAs come in a wide variety of configurations, and FIG. 2B does not limit the scope of this disclosure to any particular implementation of a STA.

The non-AP MLD 111 is affiliated with multiple STAs 203a-203n (which may be referred to, for example, as STA1-STAn). Each of the affiliated STAs 203a-203n includes antenna(s) 205, a radio frequency (RF) transceiver 210, TX processing circuitry 215, and receive (RX) processing circuitry 225. The non-AP MLD 111 also includes a microphone 220, a speaker 230, a controller/processor 240, an input/output (I/O) interface (IF) 245, a touchscreen 250, a display 255, and a memory 260. The memory 260 includes an operating system (OS) 261 and one or more applications 262.

The illustrated components of each affiliated STA 203a-203n may represent a PHY layer and an LMAC layer in the OSI networking model. In such embodiments, the illustrated components of the non-AP MLD 111 represent a single UMAC layer and other higher layers in the OSI model, which are shared by all of the affiliated STAs 203a-203n.

For each affiliated STA 203a-203n, the RF transceiver 210 receives from the antenna(s) 205, an incoming RF signal transmitted by an AP of the network 100. In some embodiments, each affiliated STA 203a-203n operates at a different bandwidth, e.g., 2.4 GHz, 5 GHz, or 6 GHz, and accordingly the incoming RF signals received by each affiliated STA may be at a different frequency of RF. The RF transceiver 210 down-converts the incoming RF signal to generate an intermediate frequency (IF) or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

For each affiliated STA 203a-203n, the TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205. In embodiments wherein each affiliated STA 203a-203n operates at a different bandwidth, e.g., 2.4 GHz, 5 GHz, or 6 GHz, the outgoing RF signals transmitted by each affiliated STA may be at a different frequency of RF.

The controller/processor 240 can include one or more processors and execute the basic OS program 261 stored in the memory 260 in order to control the overall operation of the non-AP MLD 111. In one such operation, the main controller/processor 240 controls the reception of forward channel signals and the transmission of reverse channel signals by the RF transceiver 210, the RX processing circuitry 225, and the TX processing circuitry 215 in accordance with well-known principles. The main controller/processor 240 can also include processing circuitry configured to facilitate EMLMR operations for MLDs in WLANs. In some embodiments, the controller/processor 240 includes at least one microprocessor or microcontroller.

The controller/processor 240 is also capable of executing other processes and programs resident in the memory 260, such as operations for facilitating multi-link adaptation based on network quality monitoring. The controller/processor 240 can move data into or out of the memory 260 as required by an executing process. In some embodiments, the controller/processor 240 is configured to execute a plurality of applications 262, such as applications for facilitating multi-link adaptation based on network quality monitoring. The controller/processor 240 can operate the plurality of applications 262 based on the OS program 261 or in response to a signal received from an AP. The main controller/processor 240 is also coupled to the I/O interface 245, which provides non-AP MLD 111 with the ability to connect to other devices such as laptop computers and handheld computers. The I/O interface 245 is the communication path between these accessories and the main controller 240.

The controller/processor 240 is also coupled to the touchscreen 250 and the display 255. The operator of the non-AP MLD 111 can use the touchscreen 250 to enter data into the non-AP MLD 111. The display 255 may be a liquid crystal display, light emitting diode display, or other display capable of rendering text and/or at least limited graphics, such as from web sites. The memory 260 is coupled to the controller/processor 240. Part of the memory 260 could include a random-access memory (RAM), and another part of the memory 260 could include a Flash memory or other read-only memory (ROM).

Although FIG. 2B illustrates one example of non-AP MLD 111, various changes may be made to FIG. 2B. For example, various components in FIG. 2B could be combined, further subdivided, or omitted and additional components could be added according to particular needs. In particular examples, one or more of the affiliated STAs 203a-203n may include any number of antenna(s) 205 for MIMO communication with an AP 101. In another example, the non-AP MLD 111 may not include voice communication or the controller/processor 240 could be divided into multiple processors, such as one or more central processing units (CPUs) and one or more graphics processing units (GPUs). Also, while FIG. 2B illustrates the non-AP MLD 111 configured as a mobile telephone or smartphone, non-AP MLDs can be configured to operate as other types of mobile or stationary devices.

Various embodiments of the present disclosure provide techniques that improve discovery of nearby devices (and/or the services made available by nearby devices). The various embodiments described herein are applicable to discovery supported by various technologies such as WiFi Aware (also known as Neighbor Awareness Networking [NAN]) Unsynchronized Service Discovery (USD), Wi-Fi Direct Service Discovery, Bluetooth, LTE sidelink, etc.

Various wireless networking technologies, such as WiFi Aware/NAN USD, Wi-Fi Direct Service Discovery, Bluetooth, LTE sidelink, etc. support discovery processes. Devices engaged in discovery typically access the communication medium, such as a shared wireless band, with some randomness in at least one of time, frequency, or code. For example, a device transmitting a discovery message may at random select for transmission a wireless channel out of the multitude of available channels, may wait a random amount of time in between retransmissions, and may hop to a different randomly selected channel for transmission after some time. An example of a device transmitting a discovery message is a USD publisher device transmitting publish messages using a service discovery extension attribute (SDEA).

On the other hand, the subscriber device performing USD selects a channel to listen on for a publish message and may listen on the selected channel intermittently. Both the channel and the duration of each dwell interval on the channel may be determined randomly or based on constraints from other ongoing WiFi operations the subscriber is engaged in.

Various embodiments of the present disclosure provide techniques that improve discovery of nearby devices (and/or the services made available by nearby devices). For ease of explanation, the various embodiments described herein are described as being performed via WiFi Aware/NAN USD. However, it should be understood that the various embodiments described herein may also be applicable to other service discovery methods, such as Wi-Fi Direct Service Discovery, Bluetooth, LTE sidelink, etc.

In some wireless networks, a USD subscriber may select a single channel for performing USD (e.g., for listening for a publish message during a passive subscribe mode or, in addition, transmitting a subscribe message during an active subscribe mode) and dwell on that channel at least intermittently. However, there are various scenarios or reasons due to which the subscriber may dwell on other channels during the USD. For example the subscriber may dwell on other channels during the USD, (a) due to NAN, WLAN, or other concurrent operation; (b) due to having multiple radios capable of at least simultaneously receiving on multiple channels; and (c) knowing beforehand (e.g., due to a predetermined configuration associated with an application or service triggering the USD) the likelihood of channels that the publisher may be using. Furthermore, some publishers may be predominantly (or exclusively) using a channel A, while other publishers may be predominantly (or exclusively) using a channel B. However, the subscriber may not know which type of the publisher is on the other end of the service discovery. Then it may be better for the subscriber to (simultaneously or alternately) dwell on both the channel A and the channel B. In view of the above, it is desirable for a USD subscriber to perform USD on other channels, such as, the channels of concurrent operation, or channels specifically chosen to improve likelihood of discovery as in the example with the channels A and B.

In some embodiments, a USD subscriber may perform USD on a plurality of channels. For example, the plurality of channels may include the channels of concurrent operation, or channels specifically chosen to improve likelihood of discovery as in the example with the channels A and B. It may be further specified to do USD subscribe on those channels that are indicated in the USD configuration (e.g., the defaultPublishChannel and the publishChannelList).

In some embodiments, if the subscriber is present on any other channel during USD (e.g., due to concurrent operation), and that channel is included in the USD configuration, then the subscriber may perform USD on that channel too.

In some embodiments, in addition to performing USD on one required channel, the subscriber may perform USD on other channels. The other channels may be restricted to those indicated in the USD configuration (e.g., the publishChannelList and the defaultPublishChannel).

In some embodiments, for a subscriber capable of enhanced multilink single radio (EMLSR) operation, the subscriber may listen on two (or more) channels simultaneously and, upon receiving a publish message that meets the requirements, transmit a response (e.g., a subscribe message or a follow-up message) on the channel on which the publish message was received. In some embodiments, for an active subscribe operation, the subscriber may transmit subscribe messages from the single transmitter on the two (or more) channels over time, sometimes transmitting on one channel and other times transmitting on another channel, thus also transmitting on the same two (or more) channel that the subscriber is also listening on (simultaneously using multiple radios).

In some wireless networks, USD publisher behavior may be limited to the “publisher in each single channel publish state operates in the defaultPublishChannel.” However, some devices are capable of operating a transmitter on multiple channels simultaneously, or have multiple transmitting radios and are thus capable of operating on multiple channels simultaneously. To exploit such capabilities, in some embodiments, the USD publisher behavior may be modified such that the publisher in each single channel publish state operates at least in the defaultPublishChannel. Therefore, where the device is capable of simultaneously operating (e.g., listening or receiving) on at least one other channel in addition to the defaultPublishChannel, the device may use that capability and perform USD on the other channel in parallel to the required operation on the defaultPublishChannel.

In some embodiments, for a publisher capable of EMLSR operation, the publisher may listen on two (or more) channels while sometimes transmitting publish messages on one of those channels for a time, then switching the transmitter to another of those channels and transmitting publish message for a time and so on. However, during a SingleChannelPublish state, one of the two or more channels may be restricted to defaultPublishChannel.

In some wireless networks, subscribe operations may be defined as active or passive type or mode. For example, a subscribe instance can be configured on the device as either passive or active.

In passive type subscribe, the subscriber does not transmit any subscribe messages, but checks for matches in received publish messages. When passive subscribe is configured, the subscriber device listens for the publish messages containing the configured service ID and satisfying other configured conditions. When such a publish message is received, the (discovery engine of the) subscriber device declares a DiscoveryResult event to the application or service that configured the subscribe operation. Also included in the declaration is any service specific information (SSI) and other information associated with the received publish message.

In active type Subscribe, the subscriber additionally transmits subscribe messages. When active subscribe is configured, the device additionally actively transmits (e.g., periodically or repeatedly) subscribe messages containing the configured service ID. This subscribe message is seen by a publisher of the service as a request to publish the service in a unicast manner to the subscriber device.

To provide for enhanced USD, wireless networks may include an additional type or mode of subscribe operation. This additional type or mode may be referred to herein as “hybrid” or “reactive.”

In some embodiments, while operating in a hybrid subscribe mode, the subscriber does not transmit subscribe messages unconditionally (as is done in active mode). However, in these embodiments, if the subscriber receives an unsolicited publish message, where the publish message results in declaration of a DiscoveryResult event, then the subscriber transmits a subscribe message.

In some embodiments, a subscribe message transmission may be repeated a few times. For example, the subscribe message may be repeated until a until a solicited publish message is received (e.g., from the same publisher whose unsolicited publish message triggered the DiscoveryResult event). In embodiments such as these, the subscribe message transmissions may be stopped upon receiving the solicited publish message. In some embodiments, if the subscriber receives a subsequent unsolicited publish message, where the publish message results in declaration of a DiscoveryResult event, the subscriber may once again transmit a subscribe message.

In some embodiments, in order to configure a subscribe instance in a hybrid mode as described herein, the type in the configuration may be indicated as “reactive” or “hybrid” (instead of “active” or “passive”. Alternatively, in some embodiments, the “type” may be indicated as “active” but the query period may be set to such a value that is not used for “active” subscribe, (e.g., a value of ‘0’, ‘Infinity’, or ‘−1’. Therefore, configuring the type as “active” and query period as such a pre-identified value can indicate that a “hybrid” type of subscribe operation is being configured.

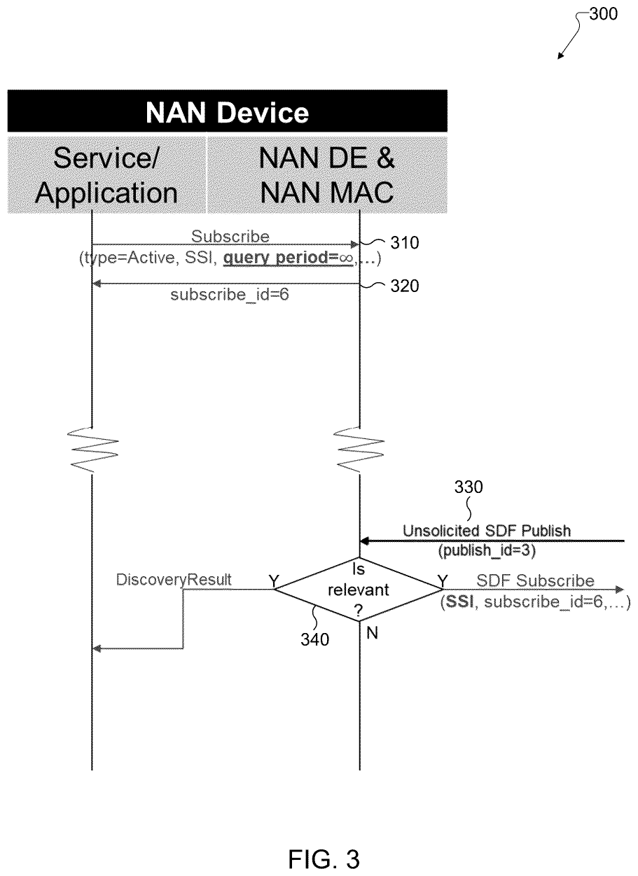

FIG. 3 illustrates an example method for reactive mode subscribe 300 according to embodiments of the present disclosure. An embodiment of the method illustrated in FIG. 3 is for illustration only. One or more of the components illustrated in FIG. 3 may be implemented in specialized circuitry configured to perform the noted functions or one or more of the components may be implemented by one or more processors executing instructions to perform the noted functions. Other embodiments of a method for reactive mode subscribe could be used without departing from the scope of this disclosure.

In the example of FIG. 3, the method 300 is performed by a NAN device. The method beings at step 310. At step 310, a service/application of the NAN device configures the NAN device's discovery engine (DE) and media access control (MAC) in reactive subscribe mode by setting the subscribe type to “active” and specifying a query period of infinity. In response, at step 320, the NAN DE and NAN MAC set the subscribe ID to “6”, which is reported to the service/application.

At step 330, the NAN DE and NAN MAC receive an unsolicited publish message in a service discovery frame (SDF). In response, at step 340, the NAN DE and NAN MAC determine whether the unsolicited publish message is relevant for the service/application. If unsolicited publish message is relevant for the service/application, the NAN DE and NAN MAC transmit a subscribe message in an SDF to the publisher that transmitted the unsolicited publish message, and indicate a DiscoveryResult to the service/application. Otherwise, if the unsolicited publish message is not relevant for the service/application, the NAN DE and NAN MAC take no action.

Although FIG. 3 illustrates one example method for reactive mode subscribe 300, various changes may be made to FIG. 3. For example, while shown as a series of steps, various steps in FIG. 3 could overlap, occur in parallel, occur in a different order, occur any number of times, be omitted, or replaced by other steps.

Since in “reactive” mode as described herein, the subscribe message is sent in response to a relevant publish message, in some embodiments, such a subscribe message may be sent in a unicast manner to the publisher who caused this subscribe message to be sent.

Being able to explicitly configure the hybrid subscribe operation and operating in the hybrid subscribe operation as described herein has many benefits. During hybrid subscribe operation, upon receiving a relevant unsolicited publish message (i.e., one resulting in a DiscoveryResult event declaration), a subscribe message carrying SSI and other preconfigured information may be automatically and quickly transmitted by the (discovery engine of the) subscriber.

If instead, subscribe were configured as passive, then such a subscribe message may not be automatically and quickly transmitted in response to receiving the unsolicited publish message. To transmit such a subscribe message, the application or service layer will first receive and process the DiscoveryResult event declaration and then configure:
an active Subscribe instance with suitable parameters (e.g., by calling the subscribe method), or
a follow-up message (e.g., by calling a transmit method with a reference to the information in DiscoveryResult event [as the follow-up message is transmitted in a unicast manner and refers to a specific instance_id of the received message that caused this follow-up message to be transmitted]).

Such communication between the discovery engine and application/service layer typically has large delay and response time, and may also incur more power due to wake up or interaction between the host and chipset.

Similarly, if instead of hybrid, the subscribe instance were configured as active, the subscriber may transmit subscribe messages unconditionally (instead of only in response to a relevant unsolicited publish message). This can incur more power consumption, interference, and may be unsuitable in situations where a publisher is rarely expected to be in range.

When a subscribe message is sent in a unicast matter (e.g., in response to a “reactive” subscribe as described herein), the subscriber may not expect a solicited publish message in response. On the other hand, at the USD publisher, upon receiving a relevant unicast subscribe message (e.g., one meeting the publish trigger conditions or causing a DiscoveryReceived event declaration as described later herein), the publisher may not send a solicited publish message (or the publisher may send a solicited publish message only a few times). In contrast, upon receiving a relevant multicast subscribe message, the publisher may keep sending solicited publish messages until the publisher receives a follow-up message or a countdown timer expires. Similar to receiving a relevant unicast subscribe message, if the publisher receives a relevant follow-up message without SSI (e.g., one causing a receive event declaration), the publisher may send one or a few unicast publish messages to the sender of the follow-up message (i.e., the USD publisher may follow a similar behavior upon receiving a relevant unicast subscribe message or a follow-up message without SSI [for such a message is unicast]).

As an alternative to the hybrid subscribe mode described here, a service/application of a NAN device may configure a partial follow-up message (instead of a subscribe message) in the discovery engine, and have the discovery engine complete this follow-up message and send it out automatically and immediately upon receiving a relevant publish message as follows:
The service/application may configure a follow-up message by providing SSI and other information used for a follow-up message, except the instance_id of a received message.
   The instance_id of a received message-a publish or a subscribe message in whose response the follow-up message is being sent—is used for sending a follow-up message. However, the follow-up message is configured before a relevant message has even been received. This is achieved as follows:
   Instead of providing the instance_id of a received message, the service/application provides a reference (e.g., subscribe_instance_id) of a subscribe instance configured on the device. In some embodiments, this may be limited to passive subscribe.
      Note that a subscribe instance processes received publish messages and declares a DiscoveryEvent when a relevant publish message is received. An objective of providing the discovery engine a reference of a subscribe instance is to tell the DE that when this subscribe instance declares a DiscoveryEvent, the partially configured follow-up message is to be sent to the publisher whose message caused the declaration of a DiscoveryEvent. Therefore, the DE is to obtain the missing instance_id (i.e., missing from the configuration of the follow-up message) from the publish message that causes the declaration of the DiscoveryResult event for the subscribe instance indicated in the configuration of follow-up message.
   When the referenced subscribe instance declares a DiscoveryResult event, the DE obtains the publish_instance_id from the publish message that caused the declaration. The DE completes the follow-up message by using the publish_instance_id (e.g., by setting requestor_instance_id in the follow-up message to the publish_instance_id) and sends the follow-up message to the publisher of the received message that caused the declaration.

This method may be referred to as configuring a “provisional” or “conditional” follow-up message. This provisional follow-up message is configured as a response to a message that is yet to be received or may never be received. Therefore, such a provisional follow-up configuration includes a reference to a subscribe instance running on the device. When that subscribe instance declares a DiscoveryResult event, this triggers the completion of and transmission of the provisional follow-up message.

Various embodiments described herein may also help a passive subscriber (performing NAN Service Discovery with NAN synchronization [NSD]) discover a USD publisher.

In some embodiments, a DiscoveryResult event may be enhanced to include an indication that the received publish message that caused the DiscoveryResult event was sent by a USD publisher. In current wireless networks, a publish message does not indicate if it is being sent by a USD publisher or an NSD publisher. In some embodiments, a reserve bit or a presently unused combination of bits in the publish SDEA may be used to indicate this information.

In some embodiments, address field A3 in the NAN SDF may be used to identify if the SDF is being transmitted by a USD device (vs an NSD device). For example, the A3 field in the USD Publish SDF is presently set to NAN Network ID, whereas in NSD SDFs the A3 field is set to NAN Cluster ID. The problem however is that the value of NAN Nework ID (51-6F-9A-01-00-00) is also one of the valid values for NAN Cluster ID. Therefore, a receiving device may not know if the value of 51-6F-9A-01-00-00 in A3 is meant as a Network ID (implying the sender is a USD publisher) or meant as a NAN Cluster ID (implying the sender is a NSD publisher). This problem is solved by excluding the NAN Network ID from the list of valid NAN Cluster IDs (e.g., NAN Cluster IDs may be restricted to a range 51-6F-9A-01-00-01 to 51-6F-9A-01-FF-FF). In some embodiments, a few further values of the A3 address field may be reserved for now and may be used to identify new device behaviors that may be defined in the future (e.g., NAN Cluster IDs may be restricted to a range 51-6F-9A-01-00-09 to 51-6F-9A-01-FF-FF). This leaves a value of 51-6F-9A-01-00-00 in A3 address field to exclusively represent NAN Network ID. Furthermore, this leaves values 51-6F-9A-01-00-01 to 51-6F-9A-01-00-08 of the A3 address field reserved for future use, (e.g., to identify new device behaviors).

In some embodiments, when an NSD passive subscriber receives a publish message that causes a DiscoveryResult event declaration if the declaration indicates USD publish, the NSD passive subscriber may send a follow-up message (without SSI) (e.g., from the Discovery Engine). When this follow-up message cannot be sent within a current discovery window or a short time window (e.g., 80 ms), the follow-up message may be dropped, and the subscriber may send a follow-up message after receiving another publish message causing a DiscoveryResult event to be declared.

In some wireless networks, a publisher can indicate in a publish message if further service discovery (FSD) is required (or supported). This may be indicated by setting an FSD required flag in the publish message SDEA (i.e., by setting an FSD required bit in the SDEA control field to 1). If FSD is required, the subscriber and publisher can exchange further service related information using follow-up messages (or other generic service discovery methods as indicated in the publish message.) However, presently in USD operation, an FSD required flag must be set (indicating that FSD is required) for proper USD operation, even if the service does not actually require any follow-up for FSD. This is because presently in USD operation, a follow-up message with SSI is used as an indication of a certain level of success of USD operation and is used for correct flow of USD operation.

For example, when the USD publisher receives a relevant follow-up message with SSI from the subscriber, the publisher permanently stops channel hopping and looking for further subscribers. So receiving a relevant follow-up with SSI is taken by the publisher as a sign or proof that the relevant subscriber has been discovered. Similarly, from the subscriber's point of view, sending a follow-up with SSI should result in the publisher not moving on to a different channel and abandoning this subscriber. Presently, using a follow-up message with SSI is how this behavior is achieved by the USD publisher and the USD subscriber, and therefore the FSD require bit is set to 1 even if the service has no need for it. In these circumstances, the subscriber sends a follow-up message with dummy SSI to make USD work properly.

In current USD procedure, when the publisher first receives a follow-up message without SSI (and if the publisher has not received a relevant subscribe message), the publisher temporarily stops channel hopping and stays put on the current channel for a preconfigured period of time, allowing the subscriber further opportunity to process the publish message and respond.

Various embodiments of the present disclosure provide enhancements to USD to do away with mandating FSD. In some embodiments, when such enhancements are utilized, a USD publisher may be free to set ‘FSD required’ to 0 (indicating FSD is not required) or to 1 based on the service needs.

In some embodiments, when a publisher receives a subscribe message and a replied event is declared, if FSD required=1 (e.g., in the publish message), the publisher may set the pauseStateTimeout to 60 seconds after receiving the subscribe message that caused the replied event declaration. Otherwise, (i.e., if FSD required=0), the publisher may set the pauseStateTimeout to 60 seconds and reset the pauseStateTimeout such that it expires when the USD is terminated. This may alternatively be described as setting the pauseStateTimeout to a nonzero value and immediately pausing it (so it does not run down to 0 and expire). This may induce the presently defined USD publisher behavior associated with starting the pauseStateTimeout countdown timer while the timer has not expired. The USD publisher may behave in the same way as if it had received, after receiving the subscribe message, a follow-up message with SSI in SDEA form the same subscriber, causing a receive event to be declared. Since FSD required=0, the reception of the above mentioned subscribe message may now progress USD operation to the next phase (instead of waiting for a relevant follow-up message with SSI from the same subscriber.)

In some embodiments, when a publisher receives a subscribe message and a replied event is declared, the publisher may send solicited publish message to the subscriber multiple times. This is useful when FSD required=0, as there is no follow-up message to implicitly indicate that the subscriber has received the solicited publish message. In embodiments such as these, if the publisher receives any subsequent relevant subscribe messages from the same subscriber, the publisher may continue to declare a replied event and reply with a solicited publish message.

In some embodiments, if FSD required=0, the application or service that started the USD Publish, may send a terminate USD command after receiving a replied event declaration. In embodiments, such as these, the application may wait a short time after the replied event to terminate USD. In some embodiments, the application or service may request a solicited publish message a number of times before terminating USD.

In some embodiments, if FSD required=0, the discovery engine may automatically terminate USD after declaring the replied event (and possibly transmitting a solicited publish message a number of times). Such embodiments, may be more efficient than waiting for the application to terminate USD. In some embodiments, the discovery engine may declare a terminate event and may indicate “success” as reason for termination.

In some embodiments, if FSD required=1 and the publisher does not receive a follow-up message with an SSI field in the SDEA from the subscriber that triggered the pauseStateTimeout count down and the pauseStateTimeout expires, then the publisher may return to the single channel publish state and continue iterating between the single channel publish state and multiple channels publish state. For example, in embodiments such as these, the USD publisher should resume the discovery for a suitable subscriber, as the potential subscriber found (which resulted in setting pauseStateTimeout timer to 60 seconds for further message exchange) did not lead to a transition for a success phase of USD.

In current USD procedure, since a USD subscriber may be configured with passive subscribe, there are further complications if FSD required=0 is used. For example, current USD procedure does not allow a passive subscriber to send subscribe messages or send follow-up messages either (as FSD required=0). However, the subscriber may be unable to subscribe to the publisher without responding to USD Publish messages quickly. This problem may be solved by utilizing the hybrid subscribe mode described herein, while retaining the benefits of passive subscribe.

In some embodiments, if FSD required=0 and a USD subscriber is not configured with active subscribe, the USD subscriber may behave as if configured with hybrid subscribe as described herein.

In some embodiments, a USD subscriber configured with passive subscribe may send a follow-up message without SSI even if FSD required=0 in the publish message. In embodiments such as these, the publisher may process such a follow-up message even though the publish message indicated FSD required=0. Subsequently, the publisher may not expect or require the subscriber to send a further follow-up message (in particular a follow-up message with SSI) in these embodiments.

In some embodiments, a USD subscriber configured with passive subscribe may send a “dummy” subscribe message (e.g., fulfilling a similar role as a “follow-up without SSI”) in response to receiving an unsolicited publish message that causes declaration of a DiscoveryResult event. Such a subscribe message may be sent by the discovery engine directly (instead of waiting for the app layer to trigger it) so that the subscribe message may be sent quickly, (e.g., within 80 ms). However, in such embodiments, unlike follow-up messages, the received subscribe messages may be subject to further checks before being considered relevant. For example, if a received subscribe message does not meet a publish trigger condition, the subscribe message may be discarded. Therefore, in embodiments such as these, the dummy subscribe message is sent in a way that it meets the publish trigger conditions (or bypasses trigger condition checks). For example, the subscribe message may be sent with no matching filter, with a zero length matching filter, or with a non-zero length matching filter that does not include <length,value> pairs with a length larger than zero.

In some embodiments, an alternative USD protocol may be employed where the subscriber operates in active mode while a publisher operates in unsolicited publish mode. In embodiments such as these, the subscriber may also be channel hopping. In such embodiments, when the publisher receives a relevant subscribe message (e.g., a subscribe message that meets the publish trigger conditions), the publisher may respond with a publish message. A publisher configured in solicited mode or both-solicited-and-unsolicited mode may respond with a solicited publish message and may do so quickly, as the message is already configured in the discovery engine by the application. However, under current USD protocol, a publisher configured in unsolicited mode may not be able to perform USD correctly unless configured with the following enhancements:
In some embodiments, when a publisher receives a relevant subscribe message (in particular, one configured in unsolicited mode), the publisher may declare an event to alert the application layer. This event may be referred to as a DiscoveryReception event and is described in more detail later herein. In response to this declaration and based on the information supplied with this event, the application layer may determine to transmit a follow-up message with SSI towards the publisher (whose publish message caused declaration of the DiscoveryReception event).
In some embodiments a publisher configured in unsolicited mode that receives a relevant subscribe message, may send a dummy “solicited Publish message without SSI” or a “follow-up without SSI” to the subscriber that sent the relevant subscribe message. Such a solicited publish message without SSI may be sent by the discovery engine directly (instead of waiting for app layer to trigger it) so that it may be sent quickly (e.g., within 80 ms). However, in such embodiments, unlike follow-up messages, the received publish messages may be subject to further checks before being considered relevant (e.g., declaration of a DiscoveryResult event by the receiving subscriber). For example, if a received publish message does not cause declaration of a DiscoveryResult event at the subscriber, it may be discarded. Therefore, in embodiments such as these, the dummy solicited publish message without SSI is sent in a way that it triggers a DiscoveryResult event (or bypasses event trigger checks). For example, the publish message may be sent with no matching filter, with a zero length matching filter, or with a non-zero length matching filter that does not include <length, value> pairs with length larger than zero. Correspondingly, the USD subscriber may be configured to allow such a message (e.g., a solicited publish without SSI, when an instance of USD subscribe exists for the same service ID) to trigger a DiscoveryResult event. Upon declaration of a DiscoveryResult event, the subscriber may pause channel hopping. The pause may be temporary (e.g., 60 seconds) and the subscriber may resume channel hopping if the subscriber does not receive a further message (e.g., a follow-up with SSI) from the publisher that caused the declaration of the DisoveryResult. In some embodiments, the subscriber may cancel channel hopping altogether upon reception of a follow-up message with SSI from the said publisher.

In some embodiments, if FSD required=0 and the subscriber sends a subscribe message after declaring a DiscoveryResult event and receives a solicited publish message from the same publisher whose publish message caused the DiscoveryResult event, if the solicited Publish message causes a DiscoveryResult event declaration, then the USD subscribe may be considered successful, and the discovery engine may terminate the USD Subscribe instance and declare the termination event (e.g., with reason “success”). Alternatively, in some embodiments, if the solicited Publish message causes a DiscoveryResult event declaration, the application or service may be recommended to terminate the USD subscribe instance at this point. In embodiments such as these the application need not wait further, and the application need not transmit further subscribe messages.

In some embodiments, if FSD required=0 and the subscriber sends a subscribe message and receives a solicited publish message, if the solicited publish message causes a DiscoveryResult event declaration, then the USD subscribe may be considered successful, and the discovery engine may terminate the USD Subscribe instance and declare a termination event (e.g., with reason “success”). Alternatively, in some embodiments, if the solicited publish message causes a DiscoveryResult event declaration, the application or service may be recommended to terminate USD subscribe instance at this point. In embodiments such as these, the application need not wait further, and the application need not transmit further subscribe messages. In some embodiments, if the solicited publish message causes a DiscoveryResult event declaration, the subscriber may stop hopping channels (if the subscriber were previously doing so) and continue USD Subscribe operation on the current channel until USD is terminated.

To implement the FSD enhancements described herein, the follow-up function of the discovery engine may also be modified. In some embodiments, the follow-up function may compose or send a follow-up SDEA only if the corresponding publish or subscribe instance indicates FSD Required=1. Alternatively, in some embodiments, the follow-up function may automatically send follow-up message without SDEA when the USD subscriber is configured in passive mode. In some embodiments, a DiscoveryResult event may indicate the value of the FSD required bit of the corresponding received publish message. In some embodiments, the indication may be explicit in the form of a flag, or the indication may be implicit based on whether FSD_parameters are included in the DiscoveryResult event. In embodiments such as these, if FSD_parameters are included, this may indicate FSD Required=1 in the associated SDEA; if FSD_parameters are not included, this may indicate FSD Required=0 in the associated SDEA.

The follow-up function of the discovery engine may also be modified. In some embodiments, the follow-up function may compose or send a follow-up SDEA only if the corresponding publish or subscribe instance indicates FSD Required=1. An exception may be made for the discovery engine automatically sending a follow-up without SDEA when the USD subscriber is configured in passive mode. A DiscoveryResult event may indicate the value of FSD required bit of the corresponding received Publish message. In some embodiments, this indication may be explicit in the form of a flag, or the indication may be implicit based on whether FSD_parameters are included in the DiscoveryResult event. If FSD_parameters are included, this may indicate FSD Required=1 in the associated SDEA; if FSD_parameters are not included, this may indicate FSD Required=0 in the associated SDEA.

In some embodiments, for unambiguous operation of USD to implement the FSD enhancements described herein (as well as permit future enhancements), setting and interpreting the FSD required bit and associated FSD function selection bit may be according to the following behavior:
In some embodiments, a subscriber transmitting a subscribe SDEA may set FSD required=0, and set FSD with generic advertisement service (GAS)=0. In embodiments such as these, to allow future extension, the discovery engine may expose an interface to the application or service layer to configure the FSD required flag and set the FSD required flag in the SDEA as configured by the application or service layer.
In some embodiments, a publisher receiving a subscribe SDEA may ignore the FSD required bit (and FSD with GAS bit). In embodiments such as these, to allow future extension, the discovery engine may indicate the value of FSD required (and FSD with GAS bit) in a replied event to pass this bit to the application layer.
In some embodiments, a transmitter of follow-up SDA may set FSD required=0, and set FSD with GAS=0. In embodiments such as these, to allow future extension, the discovery engine may expose an interface to the application or service layer to configure the FSD required flag and set the FSD required flag in the SDEA as configured by the application or service layer
In some embodiments, a receiver of follow-up SDEA may ignore the FSD required bit (and FSD with GAS bit). In embodiments such as these, to allow future extension, the discovery engine may indicate the value of the FSD required (and FSD with GAS bit) in the receive event to pass this bit to the application layer.

In current USD procedure, a USD subscriber either sends a follow-up message without SSI or a subscribe message (possible if active subscribe is configured) to cause the USD publisher to temporarily stay put on the current channel. Sending a follow-up message without SSI may be seen as an unfortunate overhead. As described earlier, a follow-up without SSI may be sent quickly and automatically by discovery engine, whereas a follow-up with SSI may require the application or service layer to first receive a DiscoveryResult event and then send SSI and necessary configuration in a command to the discovery engine to transmit a follow-up. However, for some implementations or use cases, it may be possible to prepare a follow-up with SSI fast enough such that the overhead of sending a ‘follow-up without SSI’ may be avoidable. Various embodiments of the present disclosure provide for fast implementation of a follow-up with SSI.

In some embodiments, when a publisher receives a follow-up message (with or without an SSI field in the SDEA) from a subscriber, if a receive event is declared, the publisher may set the pauseStateTimeout to 60 seconds after receiving the follow-up message that caused the receive event declaration. In embodiments such as these, if the follow-up message received had SSI in the SDEA, the publisher may reset the pauseStateTimeout such that it expires when the USD is terminated. Alternatively, in some embodiments, the publisher may set the pauseStateTimeout to a nonzero value and immediately pause it (so it does not run down to 0 and expire). In some embodiments, the USD publisher may behave in the same way as if it had received, before receiving the follow-up with SSI, a follow-up message without SSI for the same subscriber that caused a receive event to be declared.

In current USD procedure, one USD publish instance may discover at most one subscriber and the publish instance stops trying to discover more subscribers after it has successfully discovered one subscriber (e.g., received a relevant follow-up with SSI from the subscriber). Then, if another USD publish instance is started to attempt to discover further subscribers, it may start the search from scratch instead of continuing from where the previous instance terminated (e.g., in terms of which channels had been scanned, for how long, which channels remained to be scanned, etc.) Various embodiments of the present disclosure provide enhancements that allow an application or service to continue USD publish even after successfully discovering one or more subscribers.

As described herein, a USD publish instance may be said to be in a success phase after it has received a relevant follow-up message with SSI from the same subscriber whose earlier follow-up or subscribe message triggered the pauseStateTimeout timer. A relevant follow-up message may be one that causes a receive even declaration. A USD Publish instance may be said to be in a success phase when the pauseStateTimeout timer has been reset such that it expires when the USD is terminated, or alternatively, the timer has been set and paused with a nonzero value.

In some embodiments, when a USD Publish instance is in a success phase, the application or service layer may send a resume command to the USD Publish instance. In embodiments such as these, upon receiving the resume command, the publisher may set the pauseStateTimeout to 0 and treat it as expired, and the publisher may return to the single channel publish state and continue iterating between the single channel publish state and multiple channels publish state. In some embodiments, the application or service layer may send the resume command after it has completed service discovery (and follow-up if needed) with the subscriber currently discovered through the USD (i.e., the subscriber that resulted in the publisher entering the success phase.) In some embodiments, the discovery engine may declare to the application or service layer when USD publish instance enters a success phase. Alternatively, the application may determine the USD instance is in success phase based on receiving a receive event declaration (for a follow-up message with SSI) or DiscoveryResult event declaration (if FSD required=0).

As previously described herein, services engaged in discovery typically access the communication medium, such as a shared wireless band, with some randomness in at least one of time, frequency, or code. For example, a device transmitting a publish message may at random select for transmission a wireless channel out of the multitude of available channels, may wait a random amount of time in between retransmissions, and may hop to a different randomly selected channel for transmission after some time. A USD publisher may iterate between a single channel publish (SCP) state and multiple channels publish (MCP) state. In the SCP state, the publisher may transmit on the configured defaultPublishChannel.

The random dwell time in each SCP state may be drawn independently from a configured distribution. For example, the random dwell time may be drawn from a uniform distribution. It may be beneficial to draw a new independent random dwell time for each SCP state visit, instead of drawing a random dwell time once and using the same value for all or multiple subsequent SCP visits.

Similarly, the dwell time in each MCP state may be drawn independently from a configured distribution. For example, the random dwell time may be drawn from a uniform distribution. It may be beneficial to draw a new independent random dwell time for each MCP state visit, instead of drawing a random dwell time once and using the same value for all or multiple subsequent MCP visits.

In current USD procedure, a replied event is declared by the discovery engine of the publisher upon transmission of a solicited publish message in response to receiving a relevant subscribe message. A relevant subscribe message may refer to a message that meets the publish trigger condition. Presently there is no event declared to indicate a reception of a subscribe message that meets the publish trigger condition. In particular, when the publisher is configured in unsolicited mode, a replied event is not generated since the publisher does not transmit a solicited message. As a result, the application or service layer may not learn of the reception of relevant subscribe messages. Various embodiments of the present disclosure provide for the application or service layer to learn of reception of relevant subscribe messages.

In some embodiments, an event declaring a reception of a relevant subscribe message may be defined. This event may be called a DiscoveryResult at the publisher or another name such as DiscoveryReception. This event may be declared for a publish instance configured in unsolicited mode. The content of the event may be the same as the relevant information in the replied event (e.g., excluding a publish_id since it is generated upon transmission of Publish and not upon reception of a Subscribe.) Declaration of this event may be useful to conclude at the discovery engine or at the application layer that a publish instance has been successful or may be terminated or updated.

Sometimes a device may be performing discovery on multiple channels concurrently or may be hopping channels. When a discovery-related event is declared, it may be useful to provide the application layer an indication of the channel on which the message causing the declaration of the event was received or transmitted. For example, in some embodiments, when a DiscoveryResult event is declared, the channel on which the publish message (that caused the DiscoveryResult declaration) was received may also be included in the event information. Similarly, in some embodiments, the event information corresponding to the DiscoveryReception event or replied event may include an indication of the channel on which the associated subscribe message was received.

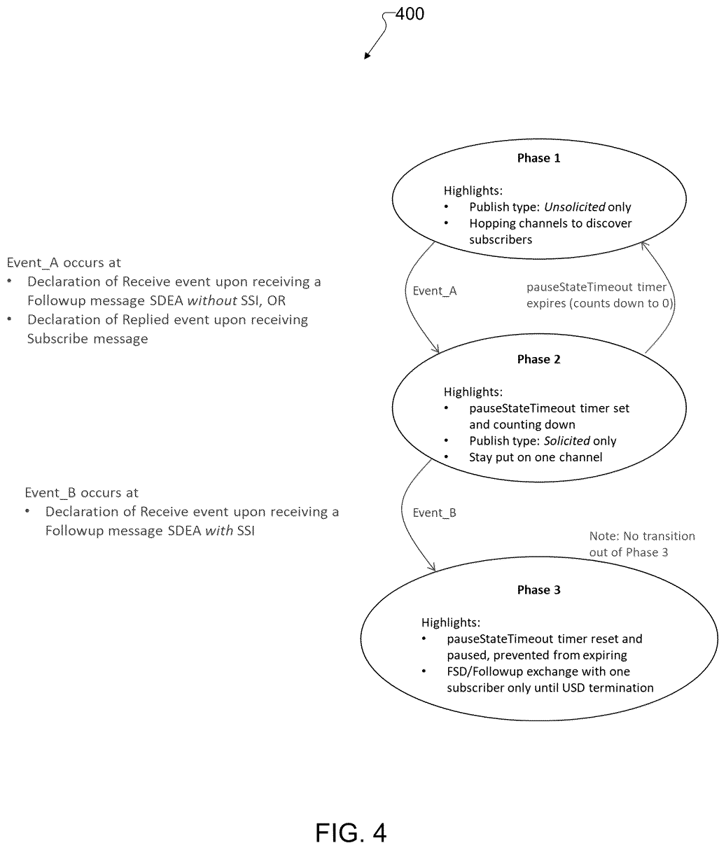

FIG. 4 illustrates an example of USD publisher behavior 400 according to embodiments of the present disclosure. The embodiment of USD publisher behavior of FIG. 4 is for illustration only. Different embodiments of USD publisher behavior could be used without departing from the scope of this disclosure.

FIG. 4 is a state transition diagram that illustrates basic USD publisher behavior. In the example of FIG. 4, the term “phase” is used instead of “state” to avoid confusion with states of SCP and MCP described herein. Some of the embodiments herein may be described as a modification of FIG. 4.

In the example of FIG. 4, if the USD sets FSD required=0 in a publish message SDEA, then follow-up messages may be not transmitted or relied upon for proper functioning of USD. Techniques previously described herein address this scenario. If FSD required=0, if the publisher is in Phase 1 and Event_A is generated, Event_A may be from declaration of a replied even upon receiving a subscribe message. Upon generation of Event_A, the USD publisher may move to Phase 2 and immediately move to Phase 3. In Phase 3, since FSD required=0, there may not be any follow-up messages exchanged. However other discovery messages such as publish, subscribe, and generic service discovery messages may still be exchanged. Instead of executing the transition as from Phase 1 to Phase 2 and then immediately to Phase 3, the transition may also be executed as moving directly to Phase 3. If FSD required=0, then Event_B may not occur. Therefore, if FSD required=0, occurrence of Event_A (typically due to a replied event) may be treated implicitly as Event_B occurring immediately after Event_A.

If FSD required=0, the Event_A may typically be generated at declaration of a replied event upon receiving a subscribe message. However, if the subscriber is configured with passive subscribe, the subscriber may not send a subscribe message. Therefore, the subscriber may be configured as active or as hybrid to induce the subscriber to transmit the subscribe message causing Event_A to occur.

In some embodiments or use-cases where a device can send out a follow-up message with SSI right away instead of first sending a follow-up message without SSI, Event_A may not be generated for proper function of basic USD. Therefore to allow such implementations to benefit from sending follow-up with SSI (without first redundantly sending a follow-up without SSI), the Event_A may also be generated at the declaration of a receive event upon receiving a follow-up message with SSI. Moreover, if Event_A is generated due to this declaration, it may be treated implicitly as Event_B occurring immediately after Event_A. The USD publisher may therefore move to Phase 2 and then immediately to Phase 3.

Phase 3 of the USD publisher may be described as the success phase of a USD Publish instance. Once the publisher enters Phase 3, the publisher is unable to transition back to Phase 1. If discovery of more subscribers is desired, another instance of USD Publish may be started (or multiple instances may be started initially and run in parallel). However, it would be beneficial to allow the application or service layer to command the discovery engine to transition the USD publisher out of Phase 3 back to Phase 1 (e.g., as if publisher were in Phase 2 and the pauseStateTimeout timer expired.)

A USD publisher may run multiple instances of a USD Publish in parallel if they are configured with same parameters (e.g., the dwell time intervals). However, if one instance of Publish enters Phase 2, and the publisher has one radio or cannot simultaneously operate on multiple channels, the channel hopping must be paused for all other instances of USD Publish as well. This may violate the dwell time requirements of USD Publish in current wireless networks, as the pause duration (of e.g., 60 seconds) may be too long. To accommodate running multiple instances, the dwell time requirements for current wireless networks may be relaxed, or the publisher may ignore the dwell time requirements for the period when at least one instance has entered Phase 2 or Phase 3.

Although FIG. 4 illustrates one example of USD publisher behavior 400, various changes may be made to FIG. 4. For example, various changes to the phases could be made, etc. according to particular needs.

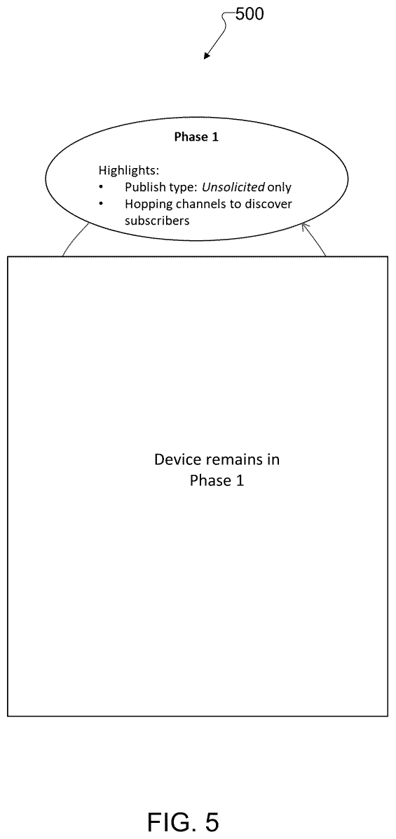

A USD without follow-up messages may be operated in multiple ways. A USD device performing channel hopping (either as a publisher or subscriber) may remain in Phase 1, or may transition between Phase 1 and Phase 2 based on events, timers, or application layer input, or may transition from Phase 1 directly to Phase 3 based on an event. These operations are illustrated in FIGS. 5-7.

FIGS. 5-7 illustrates other examples of USD publisher behavior 500-700 according to embodiments of the present disclosure. The embodiments of USD publisher behavior of FIGS. 5-7 are for illustration only. Different embodiments of USD publisher behavior could be used without departing from the scope of this disclosure.

In the example USD publisher behavior 500 of FIG. 5, a USD device performing channel hopping (either as a publisher or subscriber) remains in Phase 1.

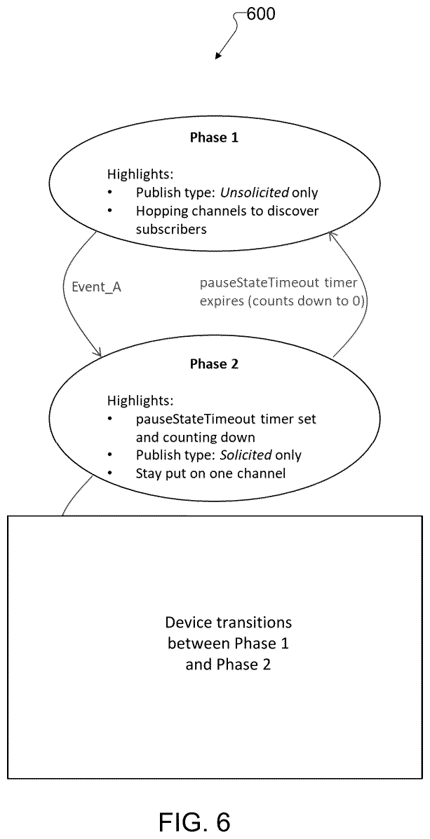

In the example USD publisher behavior 600 of FIG. 6, a USD device performing channel hopping (either as a publisher or subscriber) transitions between Phase 1 and Phase 2 based on events, timers, or application layer input.

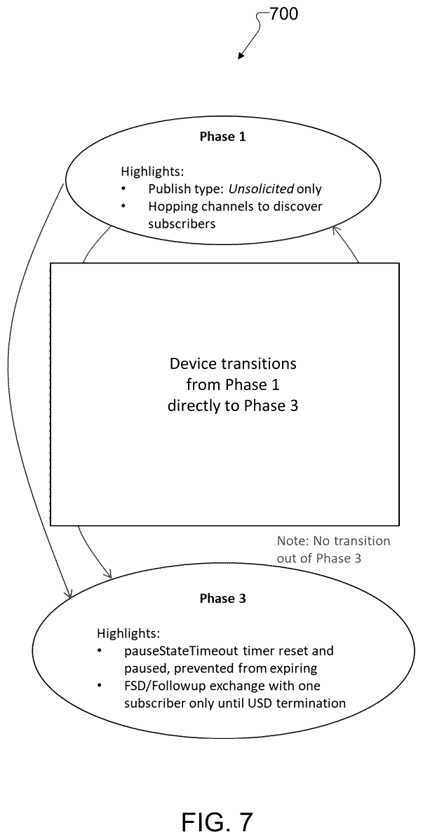

In the example USD publisher behavior 700 of FIG. 7, a USD device performing channel hopping (either as a publisher or subscriber) transitions from Phase 1 directly to Phase 3 based on an event.

Although FIGS. 5-7 illustrates some examples of USD publisher behavior 500-700, various changes may be made to any or all of FIGS. 5-7. For example, various changes to the phases could be made, etc. according to particular needs.

Instead of jointly defining the behavior of a pair of unsynchronized devices-one publisher and the other subscriber—in a manner that they (or applications or services running on them) are reliably discoverable by each other (and can exchange further service related messages where needed), it may also be useful to describe one or more general unsynchronized device behaviors. Such behaviors may allow higher flexibility in device operation and may be more optimized for certain use-cases. For example, in some embodiments, one device (say, a publisher) following one general unsynchronized behavior with a specific configuration may be reliably discoverable by only a subset of subscriber behaviors and configurations and may not be reliably discovery by other subscriber behaviors or configurations. In embodiments such as these, it will then be the responsibility of the application or service layer to pick general unsynchronized behaviors across the devices in such a manner that they be discoverable where required. Some embodiments may define a larger variety of general unsynchronized behaviors for the applications to pick from and thus optimize performance (e.g., power, latency, concurrent operation), at the cost of some behaviors not being mutually compatible.

As described herein, a channel hopping device performing general USD (gUSD) may be referred to as a general unsynchronized channel hopper (GUCH) device. A GUCH may be a publisher or a subscriber. In some embodiments, a GUCH may be configured independently as a publisher or a subscriber as described later herein. In some embodiments, a GUCH may iterate between a SingleChannelPublish (SCP) state and MultipleChannelPublish (MCP) state as it performs discovery. In some embodiments, a GUCH may follow randomly drawn dwell intervals on various channels.

As previously noted, a GUCH may be configured as a publisher or subscriber. When configured as a publisher, a GUCH may be configured in an unsolicited, solicited, or both mode. When configured as a subscriber, a GUCH may be configured in a passive, active or reactive mode.

In some embodiments, the following events may be defined as a GUCH receiving a relevant discovery message:
If the GUCH is a publisher:
   receiving a subscribe message that meets publish trigger conditions or causes declaration of a DiscoveryReception event. Note, if the publisher is configured in solicited or both mode, then reception of a relevant message may also be defined as declaration of a replied event.
   receiving a follow-up message that causes declaration of a receive event. A distinction may be made between a follow-up message without SSI and one with SSI. For example, for the purpose of temporarily pausing the channel hopping (described later herein), a relevant follow-up message may be restricted to a follow-up without SSI message.
If the GUCH is a subscriber: receiving a publish message that causes declaration of a DiscoveryResult event. A distinction may be made between an unsolicited and a solicited publish message. For example, for the purpose of temporarily pausing the channel hopping (described later herein), a relevant discovery message may be restricted to a solicited publish message.

In some embodiments, when a GUCH receives a relevant discovery message, if the GUCH was performing channel hopping, the GUCH may temporarily pause channel hopping (e.g., for 60 seconds). In some embodiments, temporarily pausing channel hopping may be performed by setting a pauseStateTimeout countdown timer to 60s, similar to USD publisher behavior. Subsequently, upon receiving a follow-up message with SSI that causes a receive event declaration, the GUCH may permanently disable channel hopping, allowing an application to exchange one or more follow-up messages as needed by the application. In embodiments such as these, the application may terminate gUSD on the GUCH device when the application deems discovery complete.

As described herein, a channel dweller performing general USD (gUSD) may be referred to as a general unsynchronized channel dweller (GUCD) device. In some embodiments, the GUCD may pick at lates on channel to perform gUSD on. The channel may be picked as the default discovery channel or from a PublishChannelList. In addition, in some embodiments, the GUCD may perform discovery on other channels (e.g., if the channel dweller is present on those channels due to a concurrent operation such as a WLAN connection).

In some embodiments, a GUCD may be configured as a publisher or subscriber. When configured as a publisher, the GUCD may be configured in an unsolicited, solicited, or both mode. When configured as a subscriber, the GUCD may be configured in a passive, active or reactive mode.

In some embodiments, the following events may be defined as a GUCD receiving a relevant discovery message:
If the GUCD is a publisher: receiving a subscribe message that meets publish trigger conditions or causes declaration of a DiscoveryReception event. Note, if the publisher is configured in solicited or both mode, then reception of a relevant message may also be defined as declaration of a replied event.
If the GUCD is a subscriber: receiving a publish message that causes declaration of a DiscoveryResult event.

In some embodiments, when a GUCD receives a relevant discovery message, the GUCD may respond with a discovery message. The response message may be a solicited publish message, subscribe message, or follow-up without SSI. The message chosen may be based on the discovery configuration of the GUCD. In some embodiments, If the received relevant discovery message SDEA indicates FSD Required=1, the GUCD may send the follow-up message without SSI to the sender of the relevant discovery message.

In some embodiments, in gUSD, if a GUCH is configured as publisher in “both solicited and unsolicited” mode and a GUCD is configured as subscriber, a similar behavior as presently defined in USD may be obtained. In some embodiments, a GUCH and GUCD may be configured in other ways to yield new behaviors that may be more suitable and optimized for certain use-cases.

In some embodiments, when a device is configured as a publisher for gUSD, the configuration may include an indication whether the publisher is either a GUCH or GUCD. In some embodiments, when a device is configured as subscriber for gUSD, the configuration may include an indication whether the subscriber is either a GUCH or GUCD.

In current wireless networks, devices that are part of a NAN cluster may set the address field A3 in the transmitted SDFs to a cluster ID. In some embodiments, if a gUSD device is to discover the devices that belong to a cluster and are transmitting SDFs with address fields intended for discovery within the cluster, then such a gUSD device may:
process received SDFs where the A3 address field may be set to any permitted cluster ID value. For example, if the gUSD device is configured as a subscriber, then the gUSD processes all publish messages with a valid cluster ID in A3 address field, and the gUSD device processes all received Publish SDFs irrespective of the value of the cluster ID in the A3 field.
transmit its multicast SDFs with A3 field set to a preconfigured value (e.g., the NAN Network ID or the first valid cluster ID). This value may be such that the devices in a cluster process SDFs with this value in the A3 address field (in addition to cluster ID in A3 address field). For example, the devices in a cluster may process SDFs with A3 set to the NAN Network ID or to the cluster ID.
transmit its unicast SDFs to the intended receiver, with A3 address field set to the same value as the A3 address field in the SDF received from the intended receiver. For example, the gUSD device may transmit a (unicast) follow-up SDF by setting the A3 field to same value as the A3 field in the received follow-up, publish, or subscribe message from the intended receiver. That is, at least one gUSD device may fill in the A3 address field of its unicast SDFs sent to an intended receiver with a value copied from the A3 address field of an SDF previously received from the intended receiver.

In some embodiments, the service interface to start a gUSD operation may include a configuration to configure the gUSD device to follow the above rules for setting the A3 address field. For example, if the gUSD device is expected to be discoverable by other devices belonging to a NAN cluster, the gUSD device may be configured to follow the above rules. Alternatively, in some embodiments, configuring a device as a GUCH may also automatically configure the device to follow the above rules for setting the A3 address field (e.g., a GUCH device is implicitly expected to be discoverable by other devices in a cluster).

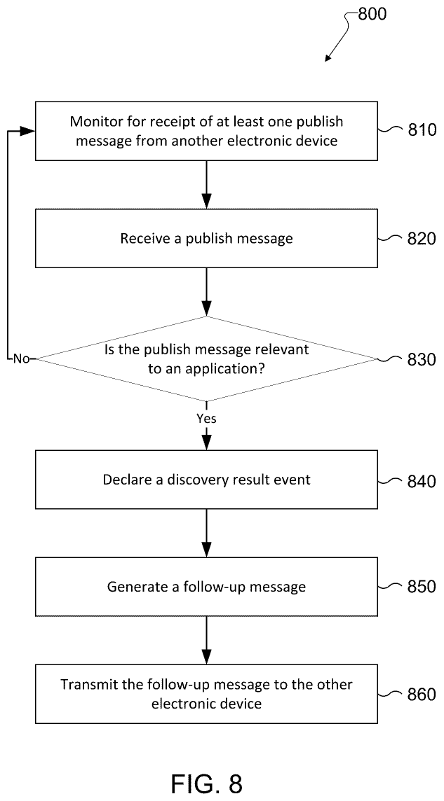

FIG. 8 illustrates an example method for USD 800 according to embodiments of the present disclosure. An embodiment of the method illustrated in FIG. 8 is for illustration only. One or more of the components illustrated in FIG. 8 may be implemented in specialized circuitry configured to perform the noted functions or one or more of the components may be implemented by one or more processors executing instructions to perform the noted functions. Other embodiments for USD could be used without departing from the scope of this disclosure.

In the example of FIG. 8, method 800 begins at step 810. At step 810, an electronic device (such as a NAN device) monitors for receipt of at least one publish message from another electronic device (such as another NAN device).

At step 820, the electronic device receives a publish message, and determines whether the publish message is relevant to an application of the electronic device at step 830. If the publish message is relevant, the method proceeds to step 840. Otherwise, if the publish message is not relevant, the method returns to step 810.

At step 840, the electronic device declares a discovery result (for example, to the relevant application). At step 850, the electronic device generates a follow-up message.

At step 860, in response to the declaration of the discovery result event, the electronic device transmits the follow-up message to the other electronic device.

In some embodiments, the first publish message may be an unsolicited publish message. In embodiments such as these, the electronic device may be configured to operate in an active subscribe mode with a query period of the active subscribe mode set to infinity, and the unsolicited publish message may be received by the transceiver while the electronic device is operating in the active subscribe mode with the query period of the active subscribe mode set to infinity. In embodiments, such as these, the follow-up message may be a subscribe message, and the electronic device may transmit the subscribe message in a unicast manner to the other electronic device.

In some embodiments, prior to receiving the first publishing message, the electronic device may generate a partial follow-up message that does not include an instance identification (ID). In embodiments such as these, in response to the declaration of the discovery result event, the electronic device may complete the partial follow-up message with instance ID information from the publish message to generate the follow-up message.

In some embodiments, the electronic device may determine whether the first publish message is a USD publish message or an NDNS publish message. In response to a determination that the first publish message is a USD publish message, the electronic device may generate the follow-up message without including SSI in the follow-up message. In embodiments such as these, the electronic device may be configured to operate in an NDNS passive mode, and the first publish message may be received while the electronic device is operating in the NDNS passive mode.

In some embodiments, the electronic device may monitor for receipt of the at least one publish message on a plurality of channels, and transmit the follow-up message to the other electronic device on a channel on which the first publish message is received. In embodiments, such as these, the electronic devices may be configured to operate in an EMLSR mode, and the electronic device may monitor for receipt of the at least on publish message on the plurality of channels simultaneously.

In some embodiments, the publish message may be an unsolicited publish message indicating that FSD is not required. In embodiments such as these, the electronic device may be configured to operate in a USD passive subscribe mode, the unsolicited publish message may be received while the electronic device is operating the USD passive subscribe mode, and the follow-up message may be a subscribe message. In some embodiments, the follow-up message may not include SSI. In some embodiments, the follow-up message may be a dummy subscribe message.

In some embodiments, the first publish message may be an unsolicited publish message indicating that FSD is not required. In embodiments such as these, the follow-up message may be a subscribe message, and the electronic device may receive a second publish message from the other electronic device after sending the subscribe message. The second publish message may be a solicited publish message. The electronic device may determine whether the second publish message is relevant to an application of the electronic device and, in response to a determination that the second publish message is relevant, declaring that a USD subscribe instance has successfully concluded.

Although FIG. 8 illustrates one example method for USD 800, various changes may be made to FIG. 8. For example, while shown as a series of steps, various steps in FIG. 8 could overlap, occur in parallel, occur in a different order, occur any number of times, be omitted, or replaced by other steps.

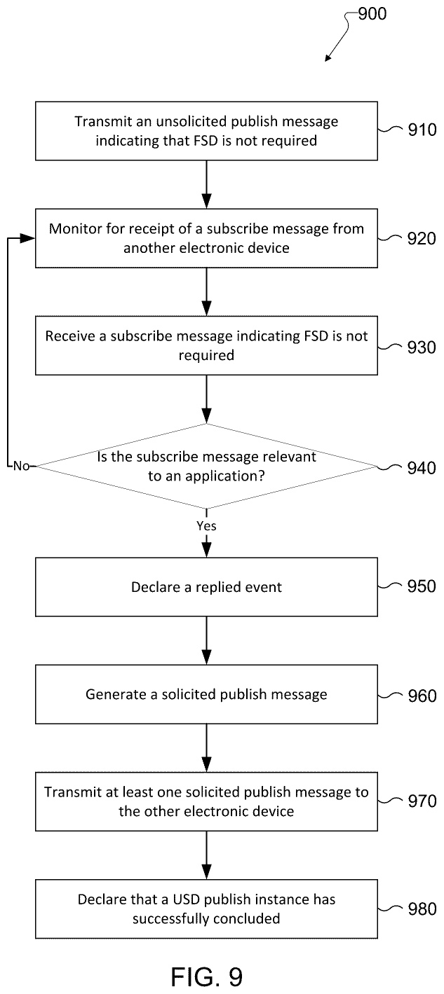

FIG. 9 illustrates another example method for USD 900 according to embodiments of the present disclosure. An embodiment of the method illustrated in FIG. 9 is for illustration only. One or more of the components illustrated in FIG. 9 may be implemented in specialized circuitry configured to perform the noted functions or one or more of the components may be implemented by one or more processors executing instructions to perform the noted functions. Other embodiments for USD could be used without departing from the scope of this disclosure.

In the example of FIG. 9, method 900 is performed by an electronic device (such as a NAN device) while the electronic device is operating in a USD publish mode. Method 900 begins at step 910. At step 910, the electronic device transmits an unsolicited publish message. The unsolicited publish message indicates that FSD is not required.

At step 920, the electronic device monitors for receipt of a subscribe message from another electronic device (such as another NAN device).

At step 930, the electronic device receives a subscribe message indicating that FSD is not required, and at step 940 determines whether the received subscribe message indicating FSD is not required is relevant to an application of the electronic device. If the subscribe message is relevant, the method proceeds to step 950. Otherwise, if the subscribe message is not relevant, the method returns to step 920.

At step 950, the electronic device declares a replied event (for example, to the relevant application). At step 960, the electronic device generates a solicited publish message.

At step 970, in response to the declaration of the discovery result event, the electronic device transmits at least one solicited publish message to the other electronic device, and declares that a USD publish instance has successfully concluded at step 980.

Although FIG. 9 illustrates one example method for USD 900, various changes may be made to FIG. 9. For example, while shown as a series of steps, various steps in FIG. 9 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. An electronic device comprising:
a transceiver configured to monitor for receipt of at least one publish message from another electronic device; and
a processor operably coupled to the transceiver, the processor configured to, upon receipt of a first publish message:
determine whether the first publish message is relevant to an application of the electronic device; and
in response to a determination that the first publish message is relevant:
declare a discovery result event;
generate a follow-up message; and
in response to the declaration of the discovery result event, cause the transceiver to transmit the follow-up message to the other electronic device.

2. The electronic device of claim 1, wherein:
the first publish message is an unsolicited publish message;
the electronic device is configured to operate in an active subscribe mode with a query period of the active subscribe mode set to infinity;
the unsolicited publish message is received by the transceiver while the electronic device is operating in the active subscribe mode with the query period of the active subscribe mode set to infinity; and
the follow-up message is a subscribe message.

3. The electronic device of claim 2, wherein the processor is further configured to cause the transceiver to transmit the subscribe message in a unicast manner to the other electronic device.

4. The electronic device of claim 1, wherein the processor is further configured to:
prior to receiving the first publish message, generate a partial follow-up message that does not include an instance identification (ID); and
in response to the declaration of the discovery result event, complete the partial follow-up message with instance ID information from the publish message to generate the follow-up message.

5. The electronic device of claim 1, wherein the processor is further configured to:
determine whether the first publish message is an unsynchronized service discovery (USD) publish message or a Neighbor Awareness Networking (NAN) discovery with NAN synchronization (NDNS) publish message; and
in response to a determination that the first publish message is a USD publish message,
generate the follow-up message without including service specific information (SSI) in the follow-up message.

6. The electronic device of claim 5, wherein:
the electronic device is configured to operate in an NDNS passive mode; and
the first publish message is received while the electronic device is operating in the NDNS passive mode.

7. The electronic device of claim 1, wherein:
the transceiver is further configured to monitor for receipt of the at least one publish message on a plurality of channels; and
the processor is further configured to cause the transceiver to transmit the follow-up message to the other electronic device on a channel on which the first publish message is received.

8. The electronic device of claim 7, wherein:
the electronic device is configured to operate in an enhanced multilink single radio (EMLSR) mode; and
the transceiver is configured to monitor for receipt of the at least one publish message on the plurality of channels simultaneously.

9. The electronic device of claim 1, wherein:
the publish message is an unsolicited publish message indicating that further service discovery (FSD) is not required;
the electronic device is configured to operate in an unsynchronized service discovery (USD) passive subscribe mode;
the unsolicited publish message is received by the transceiver while the electronic device is operating in the USD passive subscribe mode; and
the follow-up message is a subscribe message.

10. The electronic device of claim 9, wherein the follow-up message does not include service specific information (SSI).

11. The electronic device of claim 9, wherein the follow-up message is a dummy subscribe message.

12. The electronic device of claim 1, wherein:
the first publish message is an unsolicited publish message indicating that further service discovery (FSD) is not required;
the follow-up message is a subscribe message;
the transceiver is further configured to receive a second publish message from the other electronic device after sending the subscribe message, wherein the second publish message is a solicited publish message; and
the processor is further configured to:
determine whether the second publish message is relevant to an application of the electronic device; and
in response to a determination that the second publish message is relevant, declare that an unsynchronized service discovery (USD) subscribe instance has successfully concluded.

13. An electronic device comprising:
a transceiver configured to, during an unsynchronized service discovery (USD) publish mode:
transmit an unsolicited publish message, the unsolicited publish message indicating that further service discovery (FSD) is not required; and
after transmission of the unsolicited publish message, monitor for receipt of a subscribe message from another electronic device; and
a processor operably coupled to the transceiver, the processor configured to, upon receipt of a subscribe message indicating that FSD is not required:
determine whether the subscribe message is relevant to an application of the electronic device; and
in response to a determination that subscribe message is relevant:
declare a replied event;
generate a solicited publish message; and
in response to declaration of the replied event:
cause the transceiver to transmit at least one solicited publish message to the other electronic device; and
declare that a USD publish instance has successfully concluded.

14. A method of operating an electronic device, the method comprising:
monitoring for receipt of at least one publish message from another electronic device;
upon receipt of a first publish message, determining whether the first publish message is relevant to an application of the electronic device; and
in response to a determination that the first publish message is relevant:
declaring a discovery result event;
generating a follow-up message; and
in response to the declaration of the discovery result event, transmitting the follow-up message to the other electronic device.

15. The method of claim 14, wherein:
the first publish message is an unsolicited publish message;
the electronic device is configured to operate in an active subscribe mode with a query period of the active subscribe mode set to infinity;
the unsolicited publish message is received by the electronic device while the electronic device is operating in the active subscribe mode with the query period of the active subscribe mode set to infinity; and
the follow-up message is a subscribe message.

16. The method of claim 14, further comprising:
prior to receiving the first publish message, generating a partial follow-up message that does not include an instance identification (ID); and
in response to the declaration of the discovery result event, completing the partial follow-up message with instance ID information from the publish message to generate the follow-up message.

17. The method claim 14, further comprising:
determining whether the first publish message is an unsynchronized service discovery (USD) publish message or a Neighbor Awareness Networking (NAN) discovery with NAN synchronization (NDNS) publish message; and
in response to a determination that the first publish message is a USD publish message,
generating the follow-up message without including service specific information (SSI) in the follow-up message.

18. The electronic device of claim 14, wherein:
receipt of the at least one publish message is monitored for on a plurality of channels; and
the follow-up message to the other electronic device is transmitted on a channel on which the first publish message is received.

19. The electronic device of claim 14, wherein:
the publish message is an unsolicited publish message indicating that further service discovery (FSD) is not required;
the electronic device is configured to operate in an unsynchronized service discovery (USD) passive subscribe mode;
the unsolicited publish message is received by the electronic device while the electronic device is operating in the USD passive subscribe mode; and
the follow-up message is a subscribe message.

20. The electronic device of claim 14, wherein:
the first publish message is an unsolicited publish message indicating that further service discovery (FSD) is not required;
the follow-up message is a subscribe message; and
the method further comprises:
receiving a second publish message from the other electronic device after sending the subscribe message, wherein the second publish message is a solicited publish message;
determining whether the second publish message is relevant to an application of the electronic device; and
in response to a determination that the second publish message is relevant, declaring that an unsynchronized service discovery (USD) subscribe instance has successfully concluded.
